(19) United States
(12) Patent Application Publication
(10) Pub. No.: US 2024/0384859 A1
(43) Pub. Date: Nov. 21, 2024

(54) LUMINAIRE WITH ADJUSTABLE LINEAR BEAM SPREAD

(71) Applicant: Luminii LLC, Niles, IL (US)

(72) Inventor: Chris Gladden, Lakewood, CO (US)

(21) Appl. No.: 18/663,818

(22) Filed: May 14, 2024

Related U.S. Application Data
(60) Provisional application No. 63/466,354, filed on May 15, 2023.
(60) Provisional application No. 63/602,663, filed on Nov. 27, 2023.

(51) Int. Cl. F21V 14/04; F21V 5/00; F21V 7/00; F21V 13/04; F21Y 103/10

(52) U.S. Cl. CPC F21V 14/04; F21V 5/007; F21V 7/0008; F21V 7/0083; F21V 13/04; F21Y 2103/10

(57) ABSTRACT

A lighting fixture includes an array of light sources arranged in a first plane. A corresponding array of optical elements is arranged in a second plane parallel to the first plane. The array of optical elements is further configured to be rotatable relative to the array of light sources along an axis of rotation, while also enabling each optical element to remain in the second plane. As a result the light fixture produces an output beam with an aspect ratio determined by an amount of rotation of the array of optical elements, such that the output beam can range from round, to oval, to elliptical.

### CROSS REFERENCE TO RELATED APPLICATIONS

This patent application claims priority to a co-pending U.S. Provisional Patent Application Ser. No. 63/466,354 filed May 15, 2023 entitled “Luminaire with Adjustable Linear Beam Spread”, and U.S. Provisional Application Ser. No. 63/602,663 filed Nov. 27, 2023 entitled “Luminaire with Adjustable Beam Spread”, the entire contents of each of which are hereby incorporated by reference.

### TECHNICAL FIELD

This patent application relates to optics, specifically to optical structures for directional lighting products.

### BACKGROUND

Light sources for illumination purposes, such as light emitting diodes (LEDs), incandescent or halogen lamps, emit visible radiation in a broad range of angles. In lighting applications for many purposes this broad distribution of light is undesirable and directional light is needed. Lighting fixtures that collimate and direct illumination in specific directions are highly advantageous.

This task is typically accomplished with luminaires utilizing a light engine (including a light emitting source, circuitry to provide power, and often a heat sink to dissipate waste heat) and an optical system including one or more reflective or refractive optics to collimate, shape, and mix the light output into a desirable light distribution. The optical system is typically designed to create a round beam of light, or may alternatively be designed to produce a different fixed beam shape. Some complex optical systems such as “zoom” lenses allow for adjustment of the angular divergence of a round beam shape, varying from a narrower beam to a wider beam.

Non-round beams are often desired for specific lighting applications. For example, hallways, long tables, and artwork may be preferably lit by fixtures that produce elongated beams of light. Such an elongated beam of light may be characterized by a narrow beam width in one dimension and a wider beam width in a second dimension, with the ratio of the wider beam width to the narrower beam width being the aspect ratio of the beam. Optics may be custom designed to produce certain beam widths, but often the best lighting results or greatest flexibility in lighting design would be enabled by a lighting fixture with an adjustable beam aspect ratio, allowing the degree of beam elongation to be adjusted as needed to optimize for the individual application. What is needed is a lighting fixture that provides a simple adjustment mechanism for changing the elongation of the light beam produced.

The apparatus and methods described herein make use of planar beam-steering optical systems. Several types of planar beam-steering optical systems are described in the prior art, for example in US Patent Publication US20220-0196224. FIG. 1 of that patent application (reproduced here as FIG. 1) shows an example back-firing optical system of prior art, comprising a light emitting source 100 (such as an undomed LED) and an optical element comprised of a reflective lens optic 180. The reflective lens optic 180 in this prior art embodiment is a solid optic (or “lens”) 104 made of transparent material with a refractive index greater than one (1). The solid optic 104 comprises a front face 102, an interior region 103, and a rear face 106. A reflective coating 107 is disposed on the rear face 106 and is conformal to its contours. The light source 100 is supported on a support structure 110 that provides electrical connection to the light source 100 and conducts heat away from the light source 100. The support structure 110 may, for example, be a portion of a metal-core printed circuit board. It necessarily obscures a portion of the front face 102 of the optic 104, and may be shaped in various ways to minimize this obscuration.

Light 101 from the source 100 enters the front face 102, transits through the optic interior 103 to strike the reflective coating 107 disposed on the rear face 106, then transits through the optic interior 103 again before exiting the face 102 to form the output beam 108. The direction of the output beam 108 may be controlled by adjusting the position of the light source 100 relative to the optical axis 105 of the solid optic 104, within the plane perpendicular to the optical axis 105. The solid optic 104 may be described as a “second-surface reflector” (SSR) because the optical reflection of interest occurs at the interface between the lens interior 103 and the reflective coating 107 disposed on the rear face 106.

Other planar beam-steering optical systems are described in the prior art. These include (i) optical systems in which the reflector is placed on a separate component conformal to the surface of a solid optic, (ii) optical systems in which a hollow reflector is used (with no solid optic), (iii) optical systems in which only a refractive lens is used, and (iv) catadioptric optical systems in which both a reflective lens and a refractive lens are utilized. In all cases, the optical element is underfilled by the light from light source, and the direction of the output beam may be controlled by adjusting the position of the light source relative to the optical element.

Prior art describes lighting fixtures making use of one instance of such an optical system, or of arrays of such optical systems, all contributing to a common output beam. The direction of the output beam may be adjusted by controlling the position of the array of optical elements relative to the array of light sources. Prior art also describes the ability to adjust the beam width of the overall output beam by twisting a two-dimensional array of light sources relative to the corresponding two-dimensional array of optical elements.

### SUMMARY

The prior art thus describes a mechanism for isotropically adjusting the beam width of a lighting fixture, providing a similar net effect to a “zoom” optic, but does not describe a system for adjusting beam aspect ratio. This patent application, therefore, describes designs for a lighting fixture with an adjustable beam aspect ratio.

In some aspects, the techniques described herein relate to a lighting fixture including an array of light sources arranged in a first plane. A corresponding array of optical elements is arranged in a second plane parallel to the first plane. At least some of the light sources are arranged along a straight line. The array of optical elements is further configured to be rotatable relative to the array of light sources along an axis of rotation, while also enabling each optical element to remain in the second plane. As a result the light fixture produces an output beam with an aspect ratio determined by an amount of rotation of the array of optical elements.

The optical elements may be beam steering elements, such as those that include a solid optic with a conformal reflector. The solid optic and the conformal reflector may be separate components.

The axis of rotation of the array of beam-steering optical elements may pass through a center portion of the array of light sources.

It is also possible that, for at least one rotational position of the array of beam-steering optical elements, each light source is identically positioned with respect to a corresponding one of the beam-steering optical elements.

In other embodiments, the light sources are not all uniformly positioned with respect to the array of optical elements for a given relative rotational position of the array of optical elements.

The aspect ratio of the output beam may be approximately one for a given rotational position of the array of optical elements, where the output beam is round. In other rotational positions, the output beam forms an ellipsoid or oval shape.

A baffle may be configured to restrict glare light. The baffle may or may not rotate with the array of optical elements.

An actuator may provide for adjusting the rotation of the array of optical elements. The actuator may be manually-adjustable, or driven by a motor, or some control system.

### BRIEF DESCRIPTION OF THE DRAWINGS

FIG. 1 shows a cross-section view of a back-firing optical system of prior art.

FIGS. 2A-2C show schematic views of an arrayed optical system. FIG. 2A shows the system with a zero rotation of the linear array of optical elements with respect to the linear array of light sources, FIG. 2B shows a moderate rotation, and FIG. 2C shows greater rotation.

FIG. 2D shows a schematic representation of the aggregate beam profile as the rotation is increased.

FIGS. 3A and 3B show schematic representations of a linearly arrayed optical system in which the pitch of the light sources does not match that of the optical elements. FIG. 3A shows the unrotated state and FIG. 3B shows a rotated state.

FIGS. 4A and 4B show schematic representations of a linearly arrayed optical system in which the light sources are initially skewed relative to the optical elements. FIG. 4A shows the unrotated state and FIG. 4B shows the rotated state.

FIG. 5A shows a light fixture with multiple linear segments arranged in a line.

FIG. 5B shows a light fixture with multiple linear segments arranged in a non-linear design.

FIGS. 6A and 6B show plan view of an example embodiment of a light fixture with adjustable beam elongation. FIG. 6A shows the unrotated state and FIG. 6B shows the rotated state.

FIGS. 7A and 7B show angle views of an example embodiment of a light fixture with adjustable beam elongation. FIG. 7A shows the unrotated state and FIG. 7B shows the rotated state.

FIG. 8 shows an angle view of an example embodiment of a light fixture with adjustable beam elongation and a fixed baffle.

FIG. 9 shows an angle view of an example embodiment of a light fixture with beam elongation adjustable via a thumbscrew.

FIG. 10 shows an angle view of an example embodiment of a light fixture with beam elongation adjustable via a joystick.

FIG. 11 shows an angle view of an example embodiment of a light fixture with beam elongation adjustable via a motor.

FIG. 12 shows an angle view of an example embodiment of a light fixture with beam elongation adjustable via a screw.

### DETAILED DESCRIPTION OF PREFERRED EMBODIMENTS

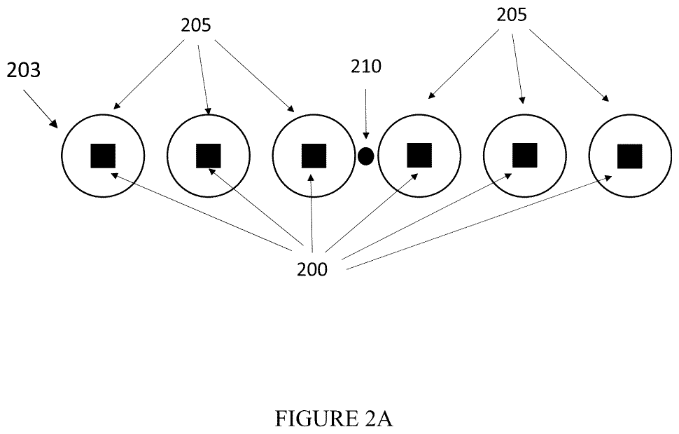

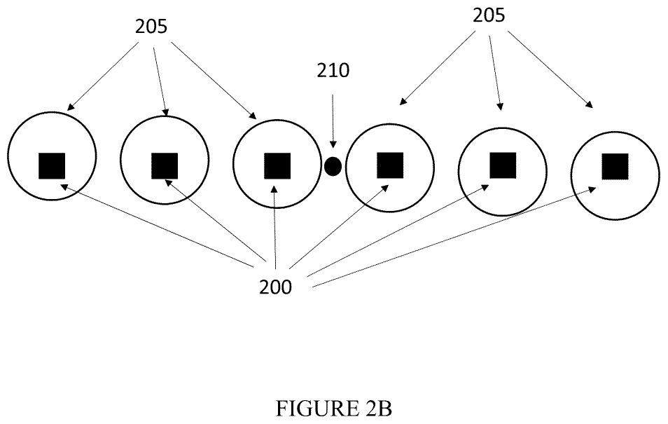

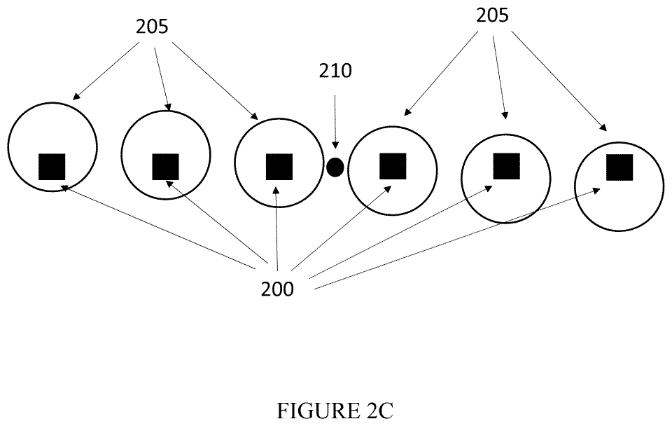

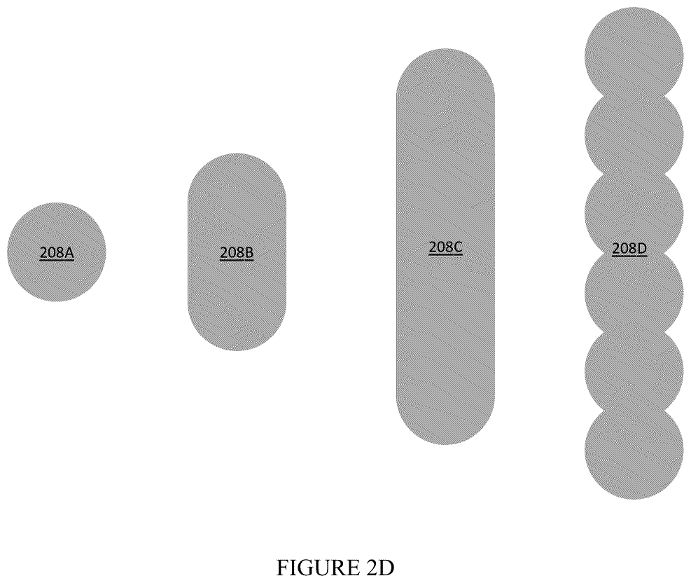

FIGS. 2A to 2C show a lighting fixture containing a linear array of planar beam-steering optical systems. An example optical system 203 includes a light source 200 and an optical element 205. For simplicity, only the light sources 200 and optical elements 205 are shown. The light sources 200 are arranged in an array in a first plane, and the optical elements 205 are arranged in a corresponding array in a second, parallel plane. All, or at least some, of the light sources 200 are arranged along a straight line within the first plane. All, or at least some, of the optical elements are arranged along a straight line within the second plane. A rotation axis 210 permits the array of optical elements 205 to be rotated relative to the array of light sources 200, with array each remaining in its respective plane.

In FIG. 2A each light source 200 is centered relative to the corresponding optical element 205. As a result, each optical system produces a light beam that is aimed in the same direction, in this case perpendicular to the plane of the luminaire. Each individual light beam has an aspect ratio of approximately one (1) as the optical system is designed to produce such a beam. Because all the beams are aimed in the same direction, the aggregate beam 208 also has an aspect ratio of approximately 1. This is shown as beam 208A in FIG. 2D.

In FIG. 2B, the array of optical elements 205 is slightly rotated (or “twisted”) relative to the array of light sources 200. As a result, each light source 200 is oriented differently relative to its corresponding optical element 205, and the output beam from each optical system is therefore aimed slightly differently. This produces an elongated beam 208B with an aspect ratio that is greater than 1, as shown in FIG. 2D.

In FIG. 2C, the array of optical elements 205 is further rotated relative to the array of light sources 200. As a result, each light source 200 is further oriented differently relative to its corresponding optical element 205, and the output beam from each optical system is therefore further aimed differently. This produces a further elongated beam 208C with an aspect ratio that is even greater than 1.

Because the displacement of the light sources from the central axis of the optical elements occurs primarily in the direction perpendicular to the linear array, the beam elongation is primarily perpendicular to the linear array.

This system provides a mechanism to produce a beam of adjustable aspect ratio by adjusting the twist of the array of optical elements 205 relative to the array of light sources 200. The aspect ratio may be adjusted from 1 (uniformly round) to a much higher value (elongated), with the limit to beam elongation being determined by the amount of rotation or “twist”, with increasing rotation eventually causing the individual beams to begin separating rather than overlapping into a single elongated beam, as seen in beam 208D in FIG. 2D. This limit is largely dependent on the number of elements in the array; an array with more elements can achieve a larger aspect ratio without the individual beams separating out.

FIG. 2D schematically shows the progressive elongation of the aggregate beam pattern as the rotation is increased. The beam pattern evolution is shown left to right as rotation is increased. Beam pattern 208A has an aspect ratio of approximately 1 in the unrotated state of the lighting fixture. The beam pattern increasingly elongates in the direction perpendicular to the arrays (that is, from round, to oval, to ellipsoid), until the individual beams become discernible in the most rotated case of beam 208D.

In the examples of FIGS. 2A to 2C, the rotation axis 210 is located in the center of the linear array, but it is not required to be located at the center and may be located elsewhere as desired.

Also, the examples of FIGS. 2A to 2C further show an array consisting of six optical systems, however the array may contain any number of optical systems.

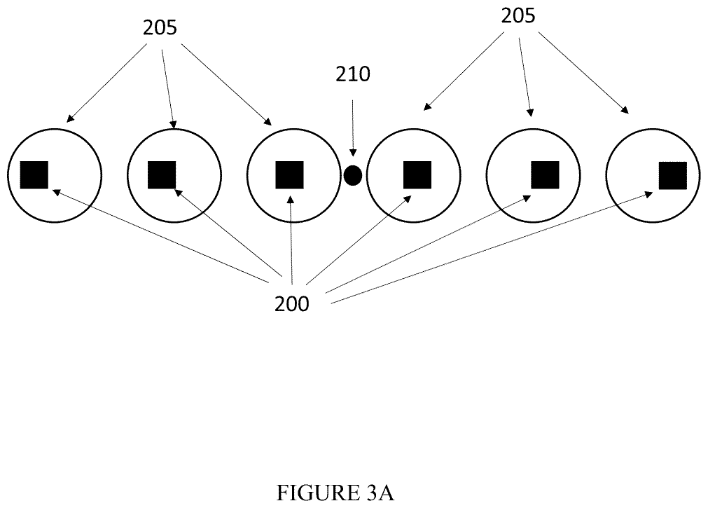

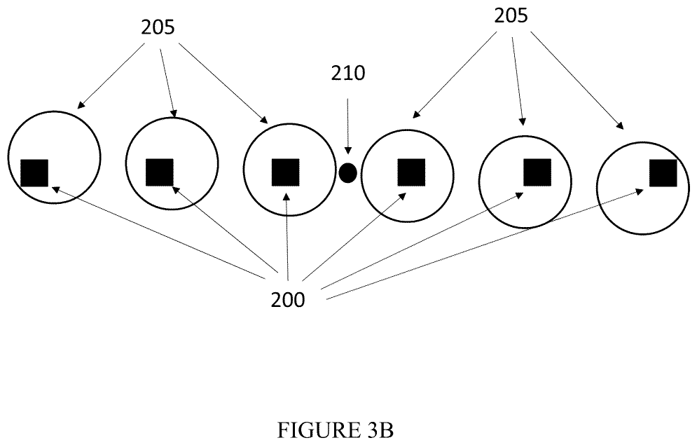

FIG. 3A shows an alternative embodiment in which the optical elements 205 in the linear array are not all aligned identically to the respective light sources 200, although each array is still confined to its respective plane. Because the optical systems 203 are not all identically aligned, the output beam from each optical system 203 is differently aimed creating a spread starting beam pattern as shown in FIG. 3A. This pattern is then altered as the array of optical elements 205 is rotated relative to the array of light sources 200. In the example of FIG. 3A, the spacing of the optical elements 205 along the linear array does not match the spacing of the light sources 200 along the linear array, so that the aggregate beam pattern initially is spread in the long axis of the lighting fixture. When the array of optical elements 205 is rotated relative to the array of light sources 200, as shown in FIG. 3B, the beam steering induced perpendicular to the axis of the arrays causes the elongated output beam to rotate toward the direction perpendicular to the axis of the lighting fixture.

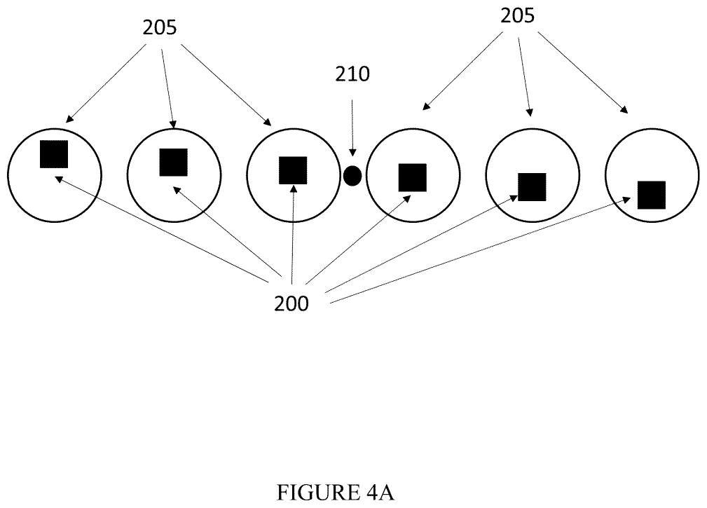

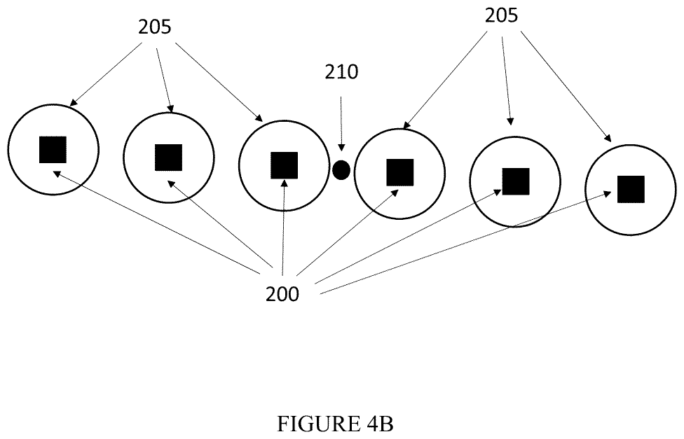

FIG. 4A shows another example of a starting orientation in which the optical elements 205 in the linear array are not all aligned identically to the respective light sources 200. In this example, the light sources 200 are variably placed relative to the optical elements 205 in the direction perpendicular to the array. This results in an initial beam that is elongated perpendicular to the array. Rotation of the array of optical elements 205 relative to the array of light sources 200 in one direction will further enhance the elongation, rotation in the other direction (as shown in FIG. 4B) will reduce elongation by steering the beams back toward a common direction.

Other initial beam patterns can be created by controlling the positions of the optical elements 205 in the array relative to the positions of the light sources 200 in the array. The initial beam pattern will be altered during rotation of the array of optical elements 205 relative to the array of light sources 200.

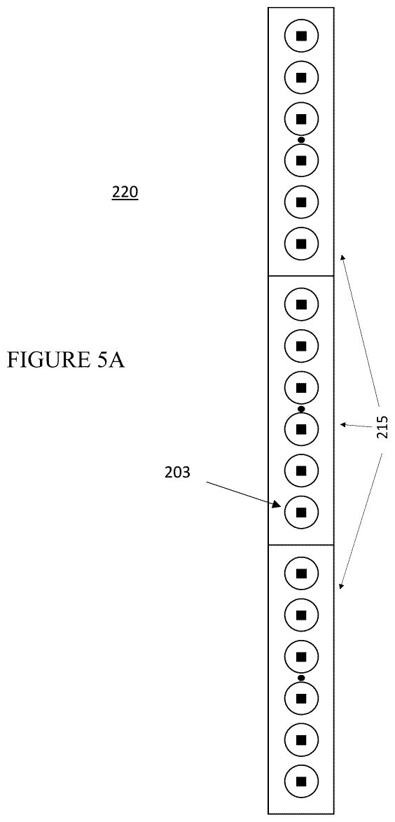

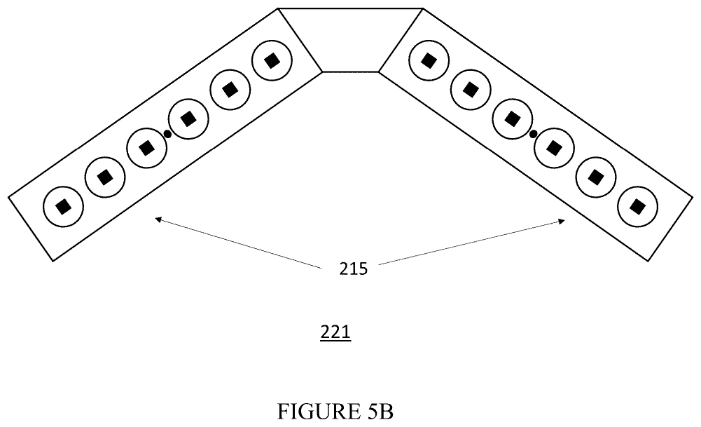

FIG. 5A shows an example lighting fixture 221 consisting of multiple linear segments 215, each segment 215 comprising an array of optical systems 203 and where each segment may be twisted to introduce beam elongation of the overall beam produced by the fixture 221 as a whole. The twist of the individual segments 215 may be designed to be separately adjustable, as explained above. Alternatively, the individual segments 215 r may be connected with a mechanical linkage (not shown) so that each segment 215 twists identically to the other segments 215, or so that the twist of one segment induces a controlled but non-identical twist in another segment. FIG. 5A shows the linear segments 215 arranged in a single line. FIG. 5B shows an alternative construction, in which linear segments 215 are arranged in a different example pattern (here a “V” shaped pattern), but where they still share the functionality described in for FIG. 5A. Multiple such arrangements with different relative orientations of segments 215 with respect to one another are possible.

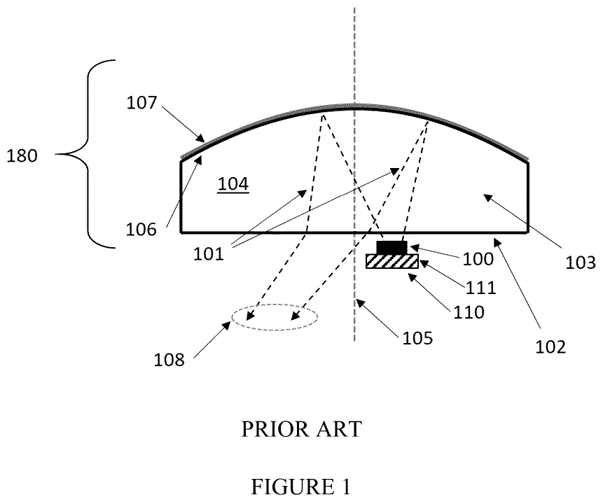

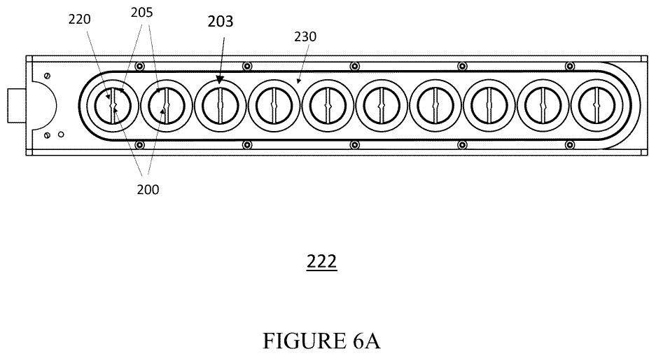

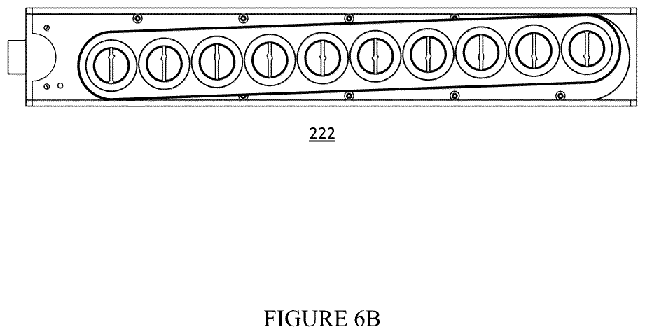

FIG. 6A shows an embodiment of another light fixture 222 made according to these principles. It comprises ten (10) individual optical systems 203 in a linear array, again with each optical system including at least a light source 200 and optical element 205. This example lighting fixture uses reflective lens optics 205, but any of the planar beam-steering optical systems of prior art may be utilized. In this example system, the light sources 200 are mounted on metal circuit board arms 220 that cross the reflective lens apertures. Each individual light source 200 may be mounted much as in the prior art of FIG. 1, showing how a light source 100 is mounted on arm 110. A baffle 230 may be attached to the lens optics 205 and serves to limit high-angle glare. FIG. 6A shows the light fixture 222 with no rotation of the array of lens optics 205 relative to the array of light sources 200. FIG. 6B shows the light fixture 222 with rotation of the array of lens optics 205 relative to the array of light sources 200 in order to elongate the output beam.

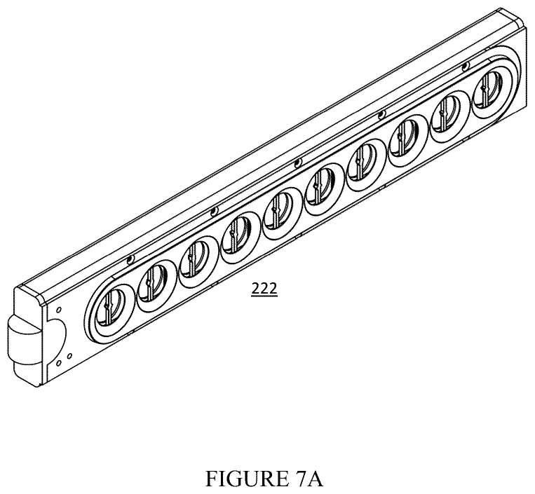

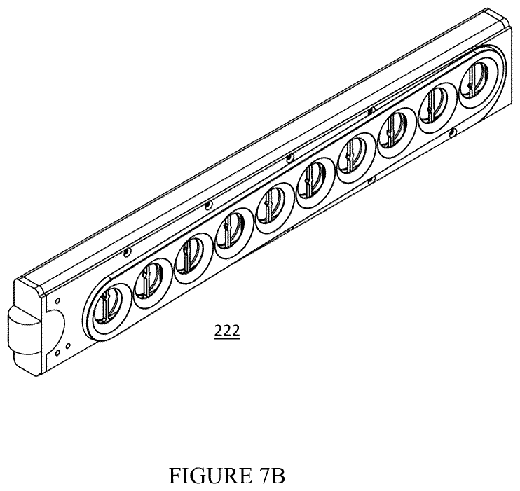

FIGS. 7A and 7B show isometric anglar views of the same lighting fixture 222 in both unrotated and rotated configurations respectively.

In the example of FIGS. 6B and 7B, the baffle 230 rotates with the array of optical elements 205, because it is attached to the optical elements 205. Because the baffle 230 is highly visible on the lighting fixture 221 or 222, its rotation may create a twisted appearance that is undesirable.

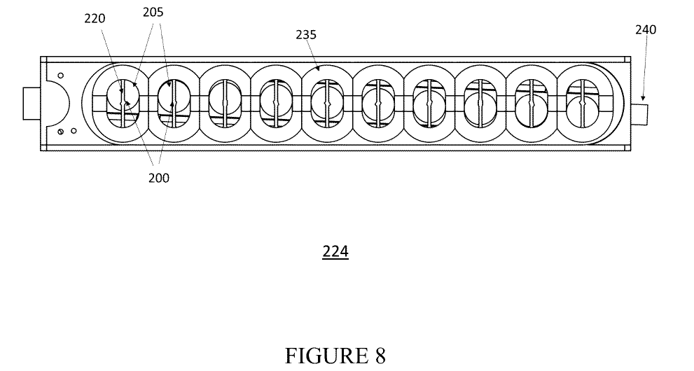

FIG. 8 shows an alternative embodiment of light fixture 224 in which a stationary baffle 235 is used that does not rotate with the array of optical elements 205, resulting in an appearance of the light fixture 224 that may be more consistent as the beam elongation is adjusted.

Various mechanisms and affordances may be used to adjust the rotation. FIG. 8 shows a tab 240 connected to the array of optical elements 205. In one example, the tab 240 is connected to a substrate or frame on which the optical elements are mounted and is free to adjust the position of the substrate or frame. The tab 240 allows for manual adjustment by a user of the rotation of the array of optical elements 205.

Other types of mechanisms may be used to accomplish rotation of the optical elements 205 relative to the light sources 200.

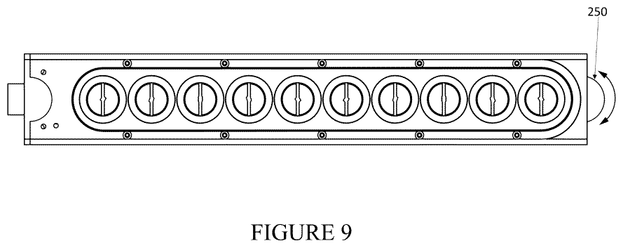

FIG. 9 shows a thumbwheel 250 that may be used to adjust the rotation.

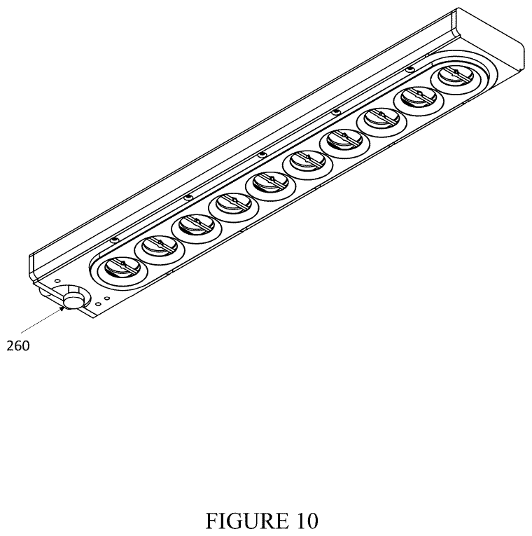

FIG. 10 shows a joystick 260 that may be used to adjust the rotation.

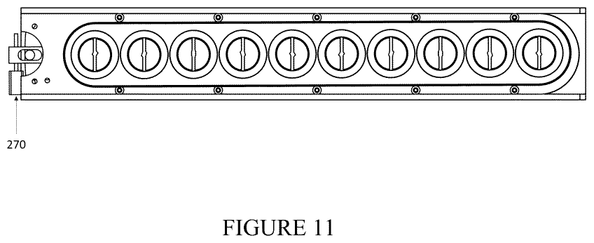

FIG. 11 shows a motor 270 that may be used to adjust the rotation via a connected power supply and control system.

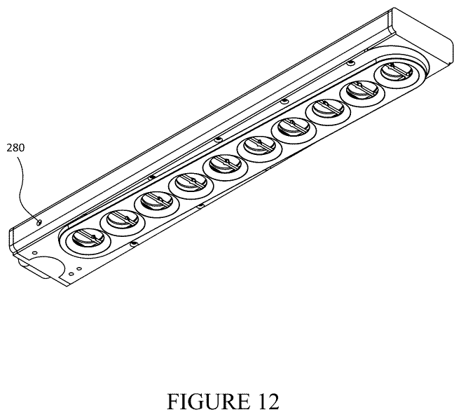

FIG. 12 shows a screw 280 that may be used to adjust the rotation.

These examples are not exhaustive, and other useful implementations of these designs within lighting systems will be evident to those skilled in the art.

1. A lighting fixture comprising
an array of light sources arranged in a first plane;
a corresponding array of beam-steering optical elements arranged in a second plane parallel to the first plane; and further wherein
the light sources are arranged along a straight line; the array of optical elements is further configured to be rotatable relative to the array of light sources along an axis of rotation, while each optical element remains in the second plane; and
the light fixture produces an output beam with an aspect ratio determined by an amount of rotation of the array of optical elements.

2. The lighting fixture of claim 1 wherein at least one of the optical elements comprises a solid optic with a conformal reflector.

3. The lighting fixture of claim 2 wherein the solid optic and the conformal reflector are separate components.

4. The lighting fixture of claim 1 wherein the axis of rotation of the array of beam-steering optical elements passes through a center portion of the array of light sources.

5. The lighting fixture of claim 1 wherein, for at least one rotational position of the array of beam-steering optical elements, each light source in the array of light sources is identically positioned with respect to a corresponding one of the beam-steering optical elements in the array of beam-steering optical elements.

6. The lighting fixture of claim 1 wherein the light sources within the array of light sources are not all uniformly positioned with respect to the array of optical elements for a given relative rotational position of the array of optical elements.

7. The lighting fixture of claim 1 wherein the aspect ratio of the output beam is approximately one for a given rotational position of the array of optical elements.

8. The lighting fixture of claim 1 wherein rotation of the array of optical elements is limited to a range in which the output beam forms an ellipsoid or oval shape.

9. The lighting fixture of claim 1 further comprising a baffle configured to restrict glare light.

10. The lighting fixture of claim 9 wherein the baffle rotates with the array of optical elements.

11. The lighting fixture of claim 9 wherein the baffle does not rotate with the array of optical elements.

12. The lighting fixture of claim 1 further comprising an actuator for adjusting the rotation of the array of optical elements.

13. The lighting fixture of claim 12 wherein the actuator is manually-adjustable.

14. The lighting fixture of claim 12 wherein the actuator is driven by a motor.
